(19) United States
(12) Patent Application Publication
(10) Pub. No.: US 2014/0014714 A1
(43) Pub. Date: Jan. 16, 2014

(54) PRODUCT AUTHENTICATION AND REGISTRATION

(71) Applicant: Kam-Fai Tang, Costa Mesa, CA (US)

(72) Inventor: Kam-Fai Tang, Costa Mesa, CA (US)

(21) Appl. No.: 13/546,460

(22) Filed: Jul. 11, 2012

(51) Int. Cl. G06K 5/00; B65D 85/00; G06K 19/06

(52) U.S. Cl. 235/375; 206/232

(57) ABSTRACT

Two pieces of identification, one is publicly accessible and the other is privately retrievable, together with a closed-loop Internet enabled computer system, provide a product authentication system for general consumer products. Barcodes and smartcards are used on the identifications as described in the application whereas other forms of identifications are also suitable.

### BACKGROUND

The present invention relates generally to product authentication and online product registration.

Counterfeit and fake product is now a worldwide rampaging problem that causes billions of monetary loss to producers. Such loss may be attributable from loss of sales to a producer, brand recognition damage, medical expenses due to sub-standard counterfeit products (such as, food and safety equipment etc.), and loss of life involving products such as fake drug and tainted food.

There are also indirect costs to the producers due to inaccurate inventory and supply chain planning, ineffective and incomplete product recall, false business intelligence reports, based on distorted customer base information, incorrectly providing support or warranty service that costs resources, and incorrectly refusing support or warranty service that costs goodwill.

In addition to the above, counterfeit products may also create a life style problem for the consumers. In particular, a consumer may fear getting a counterfeit product from an unreliable source. As such, the consumer may prefer to over pay a perceived respectable bigger retailer for a product, when in fact a small product provider may as well provide the same product at a less expensive price. Also, in some cases, a consumer may choose to repair a product instead of replace it, even though repairing may be more costly. This is because the consumer may fear that buying a replacement product may result in getting a counterfeit product that is inferior to an authentic product. In addition, fearing getting a counterfeit product, a consumer may choose to pay additional travel cost to purchase from a distant respectable source. Furthermore, a consumer who unintentionally purchased a counterfeit product may not be able to get customer support from a company, which cannot confirm the validity of the product. Also, in some cases, the counterfeit product provider may also provide product and support information for the counterfeit product or genuine product. Thus, the consumer may be getting product and support information from an unreliable source.

### BRIEF DESCRIPTION OF THE DRAWINGS

Some embodiments are described with respect to the following figures:

FIG. 1 illustrates an example of consumer product with two identifications;

FIG. 1A illustrates an example of how a returned consumer product gets re-assembled;

FIG. 2 illustrates another example of consumer product with two different kinds of identification;

FIG. 3 illustrates a paper smart label as one form of identification;

FIG. 4 shows how an identification reader is connected to a central server;

FIG. 5 shows how a Smartphone reader is connected to a central server;

FIG. 6 is a flow diagram illustrating an authentication process that may be provided by the authentication service provider in accordance with some embodiments;

FIG. 6A is a flow diagram illustrating a simplified authentication process that may be provided by the authentication service provider in accordance with some embodiments;

FIG. 7 is a flow diagram illustrating a product registration process that may be provided by the authentication service provider in accordance with some embodiments;

FIG. 8 is another flow diagram illustrating an authentication process that may be provided by the authentication service provider in accordance with some embodiments;

FIG. 8A is another flow diagram illustrating a simplified authentication process that may be provided by the authentication service provider in accordance with some embodiments; and

FIG. 9 is another flow diagram illustrating a product registration process that may be provided by the authentication service provider in accordance with some embodiments.

### DETAILED DESCRIPTION

Product authentication and/or registration may be based on two pieces of identification. The first identification is accessible outside the product package while the second identification is concealed inside the package. Both identifications have unique identification numbers or codes such that no two identifications are the same identification codes. Before making a purchase, a consumer can access the first identification to learn about the product with an Internet enabled reader. Based on the first identification, a computer server retrieves the product information via the Internet from a central data based managed by the Authentication Service Provider (ASP). Such information typically includes product brand, make, model number, manufacturing data code, lot number, and serial number. The information will then relay to the reader display to the consumer. Sometimes, the product information from the data base may include a reference to newer models or other related accessories. In some rare cases, product recall information will be displayed to alert about a product anomaly and advise the consumer to report the product to the store manager.

Once satisfied that the product is most likely authentic based on the out-of-band product information from the ASP, the consumer then decides if she wants to purchase it. After buying the product, the consumer opens the package and finds the second identification. The consumer may opt to register the product by first logging on to her user account with the ASP central server. Then the consumer scans the second identification with an Internet enabled reader. The central server may request that the consumer scan not only the second identification but also the first identification to make sure the registering consumer is the rightful owner of the product.

The first identification may be a barcode, two-dimensional (2D) barcode, or a wireless smartcard whereas the second identification could be a passcode, a magnetic strip-card, one-dimensional (1D) barcode, a 2D barcode or a password control smartcard. The reader could be an Internet enabled Smartphone with both barcode scanning and NFC (near field communication) reading functions. Or, it could be an Internet enabled computer terminal capable of reading both identifications, provided by the store.

By utilizing two pieces of identifications, a consumer can use the first identification to collect the product manufacturing message or information via the Internet. The consumer can then purchase the product and register the product with the second identification, via the Internet.

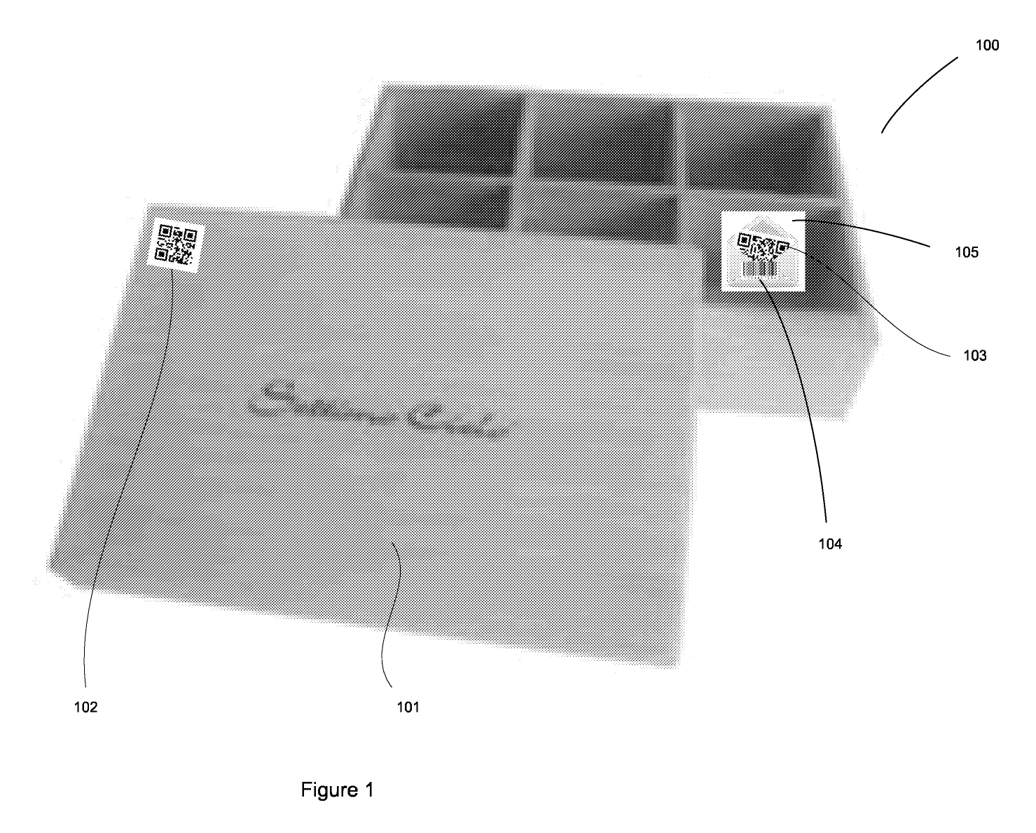

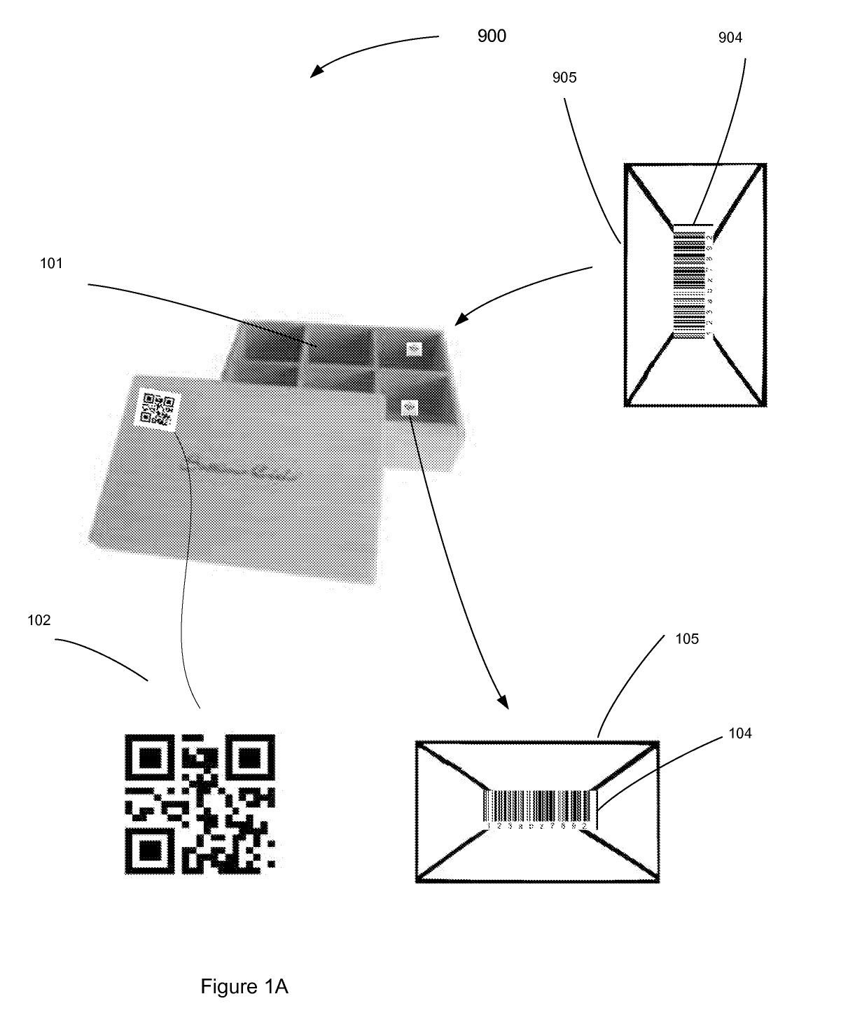

Referring now to FIG. 1, there is shown a typical consumer product 100 including a product box or package 101. The box 101 may be the package that contains the product. The box top has the first identification QR barcode 102 at the top left corner. However the bar code can be placed anywhere on the box 101. Shoppers can optically scan this QR barcode 102 before paying for it. Inside the product package 101 is an envelope 105 which has the second identification QR barcode 103 concealed inside and a tracking barcode 104 printed outside. Both QR barcodes 102 and 103 have unique identification codes. To reduce the possibility of vandalism, QR barcode 102 is typically a tamper evident label such that once put on a package surface, its 2D picture would be very much altered and render useless after attempted removal.

The Authentication Service Provider (ASP) devises a method to generate the QR barcodes 102, 103 and tracking bar code 104 so that all these codes are unique. Such information is stored in a central data base. Product manufacturer (PM) would order these QR barcode pairs from ASP. Before shipping the QR barcode pairs, ASP would log these barcode pairs assigned to the product manufacturer in its central server. Since QR barcode 103 is concealed inside the envelope 105, product manufacturer can only read the QR barcode 102 and the envelope tracking barcode 104. During the final assembly of the product 100, product manufacturer would label or affix the QR barcode 102 on the package 101 surface while putting the envelope 105 inside the package. Both QR barcode 102 and tracking barcode 104 need to be scanned and data logged into a computer data base at the assembly site. The package 101 may then be shrink-wrapped with transparent wrapper. After one lot of this product assembly was completed, product manufacturer would send an encrypted data base which includes the QR barcode 102, tracking barcode 104 and all the individual product 101 information such as their corresponding serial number, product manufacture date code, lot number, model name or manufacturing factory to the ASP. Product manufacturer may employ typical Public Key and Private Key encryption methodology with private key signing to electronically send the product lot data base to the ASP. The private key signature ensures the data base is original and without any modification. Product lot shipping schedule is included in the data base.

Upon receiving, decrypting (with the ASP private key) and verifying (with product manufacturer's public key) the product lot data information, the ASP would invoke a utility program to read the product lot data base into its central data base automatically. Based on the shipping schedule of the product lot, this lot data in the central data base is scheduled to go LIVE or ACTIVE on the same product shipping date. Until then these QR barcodes 102 and 103 are considered inactive and any query on these barcodes to the ASP server 250 will result an invalid barcode message.

FIG. 4 shows a reader 251 which has both barcode scanning 253 and NFC reading 252 capabilities. Reader 251 may be provided by the store to shoppers to collect authentication message from the ASP. It is Internet enabled and connected to the ASP server 250 via the internet.

In order to facilitate the recognition of the QR barcodes 102 and 103, they may be designed to conform to certain syntax or a language structure format. For example, the QR barcode 102 may start with “&*” then the alpha numeric code string, and end with “*&”. The QR barcode 103 may start with “%*” then the alpha numeric code string, and end with “*%”.

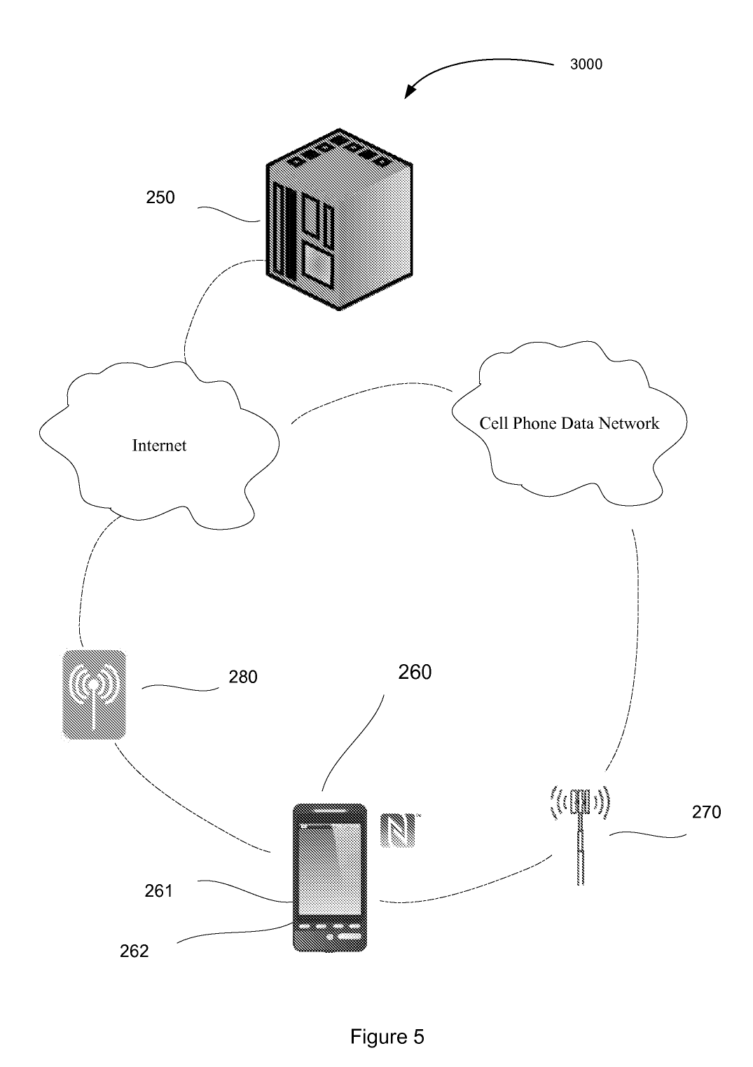

FIG. 5 shows a Smartphone 260 with both barcode reading 261 and NFC reading 262 functions. Store can loan out such Smartphone 260 to shopper to collect authentication message from the ASP. Some consumers may already have their own personal Smartphone similar to Smartphone 260. The Smartphone 260 is Internet enabled and connected to the ASP server 250 via cell tower 270 which in turn hooks up with the ASP central server 250 with cell phone data network. Consumer may opt to use the wireless WiFi service 280 provided by the store to connect her Smartphone to the ASP server 250.

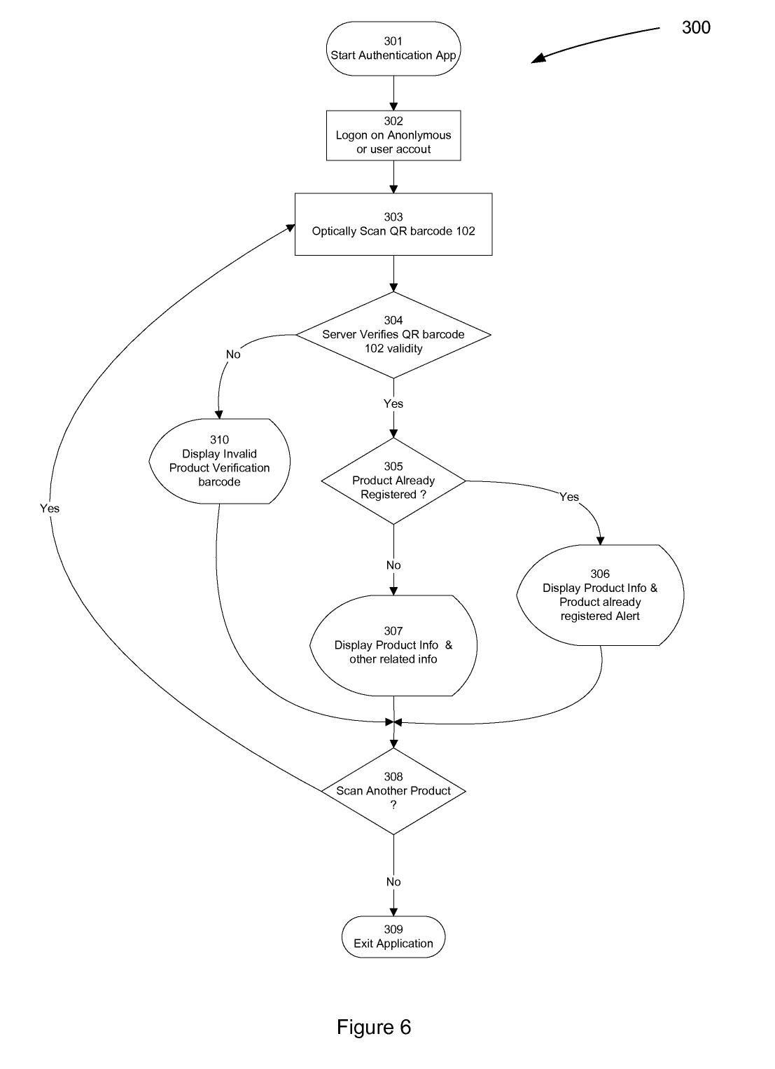

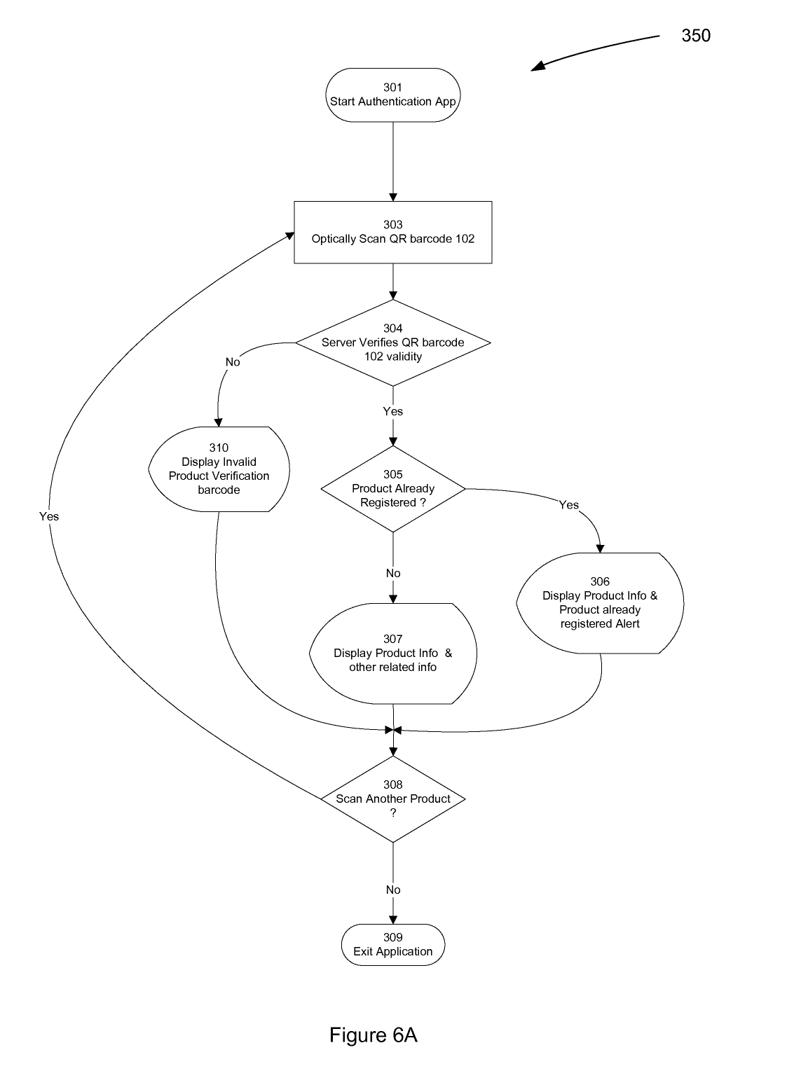

FIG. 6 shows a typical product authentication message collection flow. Consumer would first invoke the authentication application from the Internet enabled Smartphone 260 (step 301). Consumer has an option to login the ASP server 250 either with her user account or anonymous (step 302). After successfully logging on the ASP server 250, consumer would be directed to scan the QR barcode 102 on product 101. The ASP server 250 would then verify the QR barcode 102 (step 304). If valid and the product 101 had not been registered (step 305) and the QR barcode 102 is on ACTIVE status, the ASP server 250 will look up its central data base based the QR barcode 102 value. The ASP server 250 will pull the corresponding product information stored in the central data base and present the product information to the Smartphone 260. The product 101 information may include but not limited to product brand, make, model number, manufacturing date code, lot number, and serial number. In some application, the ASP server 250 may opt to present additional information, such as how many times the QR barcode 102 had been scanned, or product promotion alert, or in some rare case, a warning that the product is being recalled. After reviewing these product and additional information, consumer will be asked if she wants to scan another product (step 308). Consumer can move on to scan another product (step 303) or exit the application (step 309). Upon satisfied with the product message from step 307, consumer then decides if she wants to purchase the product 101.

However, in some rare cases, the QR barcode 102 could be smeared or damage that the Smartphone 260 cannot read it properly. After a predefined period, say 10 seconds, the ASP server 250 would present to the Smartphone 260 that the QR barcode 102 is not valid or perhaps there were logistic shipping date error that the QR barcode 102 status was INACTIVE. In some uncommon scenarios, the ASP server 250 recognizes that the product 101 had been registered based on its central data base information. The ASP server 250 may issue an alert message to Smartphone 260 that the product had been registered and alert the consumer that product 101 might be a counterfeit. The consumer is advised to take the product to the customer service of the store. The ASP server 250 may collect the necessary information, to the extent that local laws allow, like the location-based data—IP address, user account, GPS (global positioning system) coordinates, time and date. The ASP server 250 would then generate a standard report on these “invalid” QR barcode 102, product 101 already registered incidents (PARI). The report may automatically route to the ASP customer service department for further case review and actions if needed. In some cases, the product 101 manufacturer may be included in the report distribution. If indeed there were counterfeit products deemed being circulated, either the product manufacturer or the ASP customer service department may opt to report to the local law enforcement agency.

FIG. 6A shows a simplified version of authentication flow. Consumer simply invokes the application, scan the QR barcode 102, and review the Authentication message, then scan another product or exit the application. The user login step is skipped.

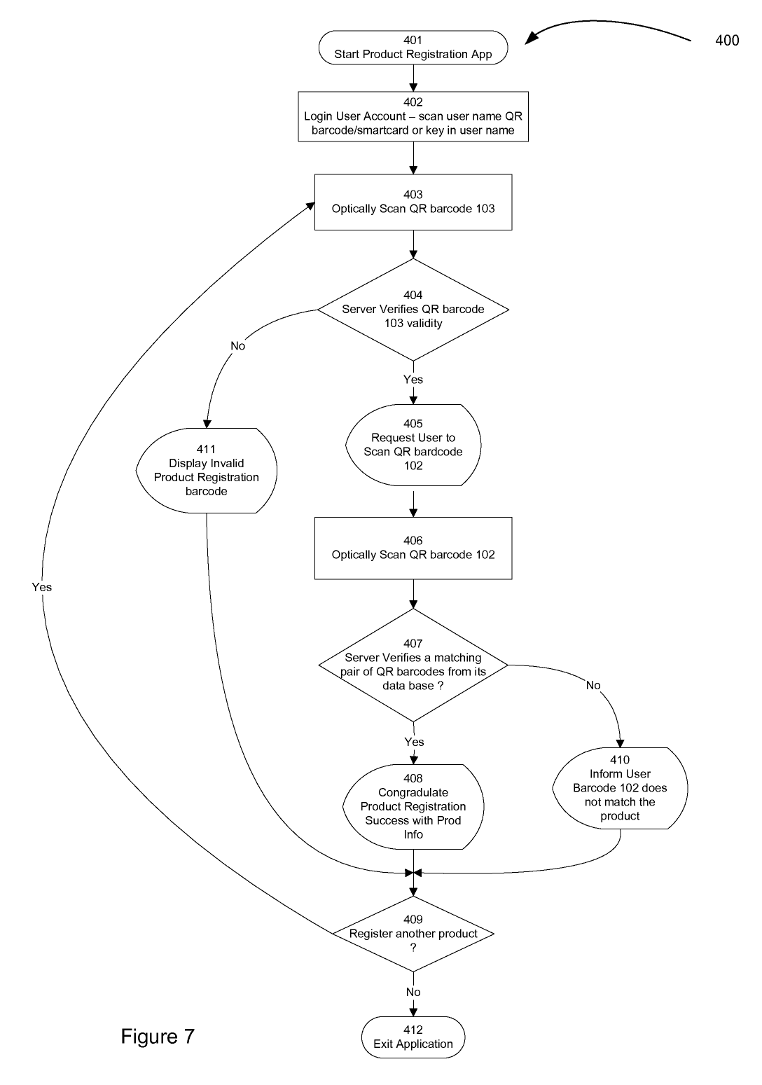

FIG. 7 shows a flow diagram for the consumer to register the product 101 online after purchasing it. The consumer should have registered an account with the ASP. The ASP would have sent a user name QR barcode tag or a smartcard with her user name for easy account logon. After invoking the product registration application (step 401), the consumer logs on her account either by keying in her user name or scanning her user name barcode or smartcard. Password is not needed in this case since it is for product registration only. Consumer will be directed to locate the QR barcode 103 which was concealed in envelope 105. Consumer will then scan the QR barcode 103 with an Internet enabled Smartphone 260 or Internet enabled reader 250. After receiving the QR barcode 103 information, the ASP server 250 then verifies it (step 404). If the QR barcode 103 is both valid and ACTIVE based on the data base, the ASP server 250 would request the consumer to scan the QR barcode 102. Consumer then scans the QR barcode 102. The ASP central server would verify if the QR barcode 102 is valid and belongs to the same product 101 from its central database (step 407). If both QR barcodes 103 and 102 match the data base information of the product 101, the ASP central server will present a congratulation message to the consumer that the product 101 was successfully registered to her account with the ASP. The ASP may opt to reward the consumer with some product loyalty program points, or it may alert the consumer with promotional products related the product 101. It then asks if the consumer wants to register another product (step 409). If the consumer has another product to register, then the process starts over from step 403; else the consumer can exit the registration application (step 412).

For some low monetary value products, the ASP server 250 may skip step 405. That is the first identification QR barcode 101 is not needed to further prove that the consumer possess the product 101. A valid second identification QR barcode 103 is sufficient to complete the registration process. However, for some expensive products, the registration process may involve further questions, like the last 3 digits of the serial number of the product, or the last two digits of the product date code. Only correct answers to such extend questions will the product registration be successful. Such measure enhances the authenticity of the product registration.

However, if the QR barcode 103 was determined invalid by the ASP server 250, or the combination of the QR barcode 103 and QR barcode 102 is not right, it could happen that the central data base was not updated properly. The ASP central server will inform the consumer that there is anomaly and alert the consumer to take the product back to the store since the product 101 could potentially be a counterfeit. As such, the ASP server 250 would try to collect as much information as possible, to the extent as permitted by the local laws, like the user information, time and date of the registration process, the location-based information—IP address, Smartphone id and GPS coordinates. The ASP server 250 then automatically generates a report based on this information and routes it to the ASP customer service department for further analysis or actions if needed. Either the product 101 manufacturer or the local law enforcement may be informed if counterfeit product was deemed being circulated. If requested by the law enforcement agency, the ASP may need to cooperate to catch the counterfeiter.

In some situation, the ASP server 250 determines that the consumer has been trying to register with bogus QR barcodes 102 and 103 multiple times. The consumer might have stolen some identification QR barcodes 102 and 103 from the product assembly workshop. Then the ASP may devise a scheme to either shut down the registration process for a determined period of time, say 24 hours, or continue with the registration then alert the ASP customer service department.

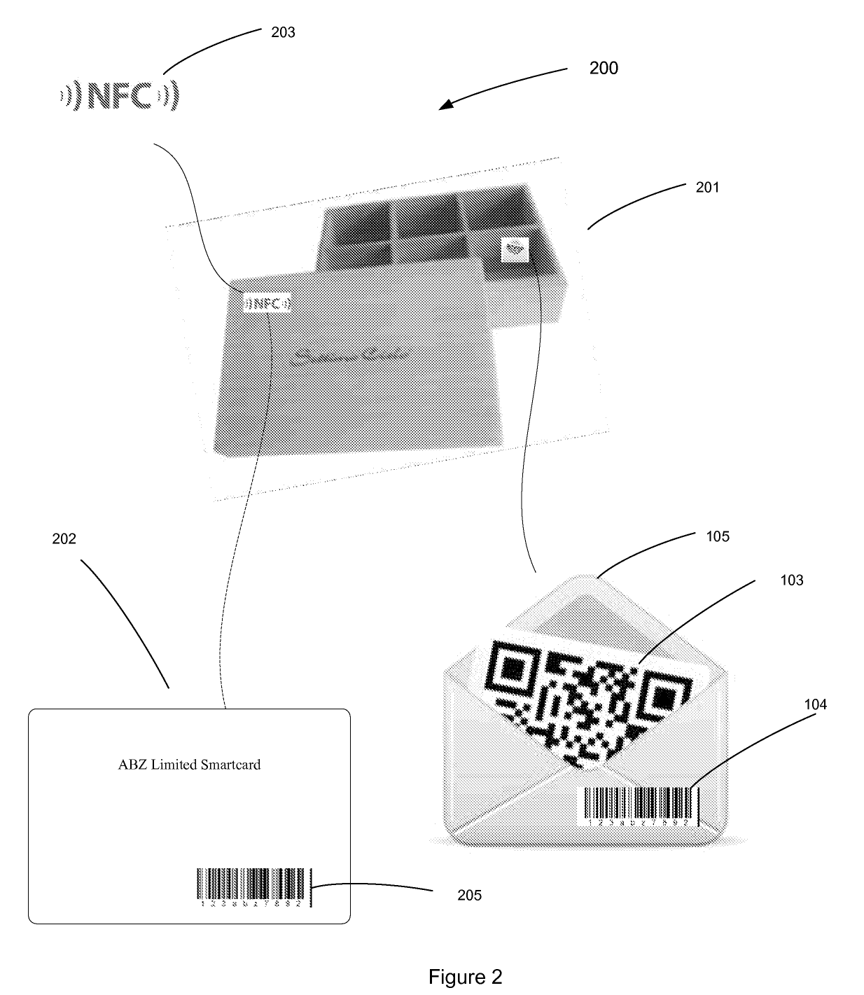

FIG. 2 shows another embodiment of using contactless smartcard 202 as the first identification and a QR barcode 103, as the second identification. The consumer product 201 has a “NFC” mark 203 printed on the package. The “NFC” mark 203 typically covers 2 cm by 3 cm area and the packaging material should be porous to electromagnetic wave. The contactless smartcard 202 is attached on the inner side of the package underneath the “NFC” mark 203. The smartcard 202 has a unique id code and has secret message stored inside which cannot be read out without proper authentication procedures. The second identification QR barcode 103 is concealed inside an envelope 105 with tracking barcode 104 and stored inside the product 201.

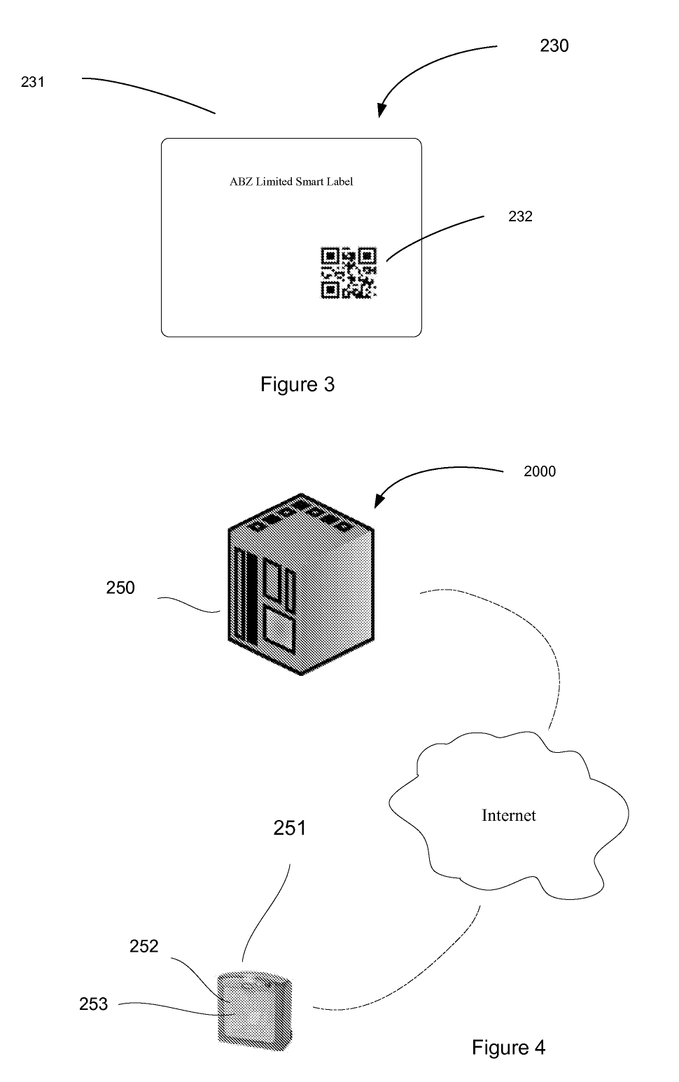

In another embodiment, the smartcard is a paper smart label 231 with an integrated circuit chip and antenna enclosed inside the paper label, as show in FIG. 3. A tracking QR barcode 232 is printed on the paper smart label 231 to allow product manufacturers to assemble their products with the paper smart label 231 without any smartcard reader but a barcode reader instead.

The main advantage of employing smartcard as the first identification object is that it is prohibitively expensive and almost impossible for counterfeiter to clone a properly programmed smartcard using industrial standard encryption or challenge and response authentication technology. Besides it is much easier and reliable to use. It is faster to read a smartcard, like within 100 ms, comparing to a second or two for optical barcode scanning. Smart chip such as the NXP Mifare UltraLight C or the Mifare Plus all have unique IDs whereas most consumer products are made to be the same within the same production batch or lot.

The ASP may employ a methodology to generate a set of secrets based on, for example, a master key, and smart chips' unique id codes. During the smartcard initialization process or programming, these secrets are written or programmed into the smart chips secret memory area. The secret memory cannot be readout directly. These stored secrets are used to perform authentication computation internally inside the smart chips. The ASP server 250 would store the smart chips' unique ids and their secrets in its central data base. In another method, the ASP data base does not need to store the secrets of the smart chips as long as the ASP knows the algorithm of the secret generation, for example, the secrets could be hash digests of an industrial Security Hashing Algorithm (SHA-256) based on a 256 bit master key and smart chip's unique id code. During smartcard authentication process, that is to verify if the smartcard 202 is the genuine, not emulation from some other active circuits, the ASP would read the smartcard 202 unique id, calculate the secret with a predefined hashing algorithm with the known master key to generate the secret. It then performs a challenge and response process to verify if the smartcard 202 stored secret is same as the ASP generated secret. If they are the same then the smartcard is genuine. Else the smartcard could be damaged or a fake.

When a product manufacturer orders the smartcards 202 and envelopes 105, the ASP would ship them a batch of smartcards 202 and the same amount of envelopes 105. These smartcards 202 and envelopes 105 would be data logged and assigned to this product 201 manufacturer in the ASP central data base. After receiving the smartcards 202 and envelopes 105, product manufacturer assemble the smartcard 202, envelope 105 and the product 201. The smartcard 202 and envelope 105 may not need to be pre-grouped as a set, as long as the product manufacturer properly scan and data log which smartcard 202 goes with which envelope 105 and the product 202. After one lot of these product 201 assembly is completed, product manufacturer would send an encrypted data base which includes the smartcard 202, tracking barcode 104 and all the individual product 201 information such as but not limited to their corresponding serial number, product manufacture date code, lot number, model name or manufacturing factory to the ASP. Product manufacture may employ typical Public Key and Private Key encryption methodology with private key signing to electronically send the product lot data base to the ASP. The private key signature ensures the data base is original and free from any modification. Product lot shipping schedule is included in the data base.

Upon receiving, decrypting (with the ASP private key) and verifying (with product manufacturer's public key) the product lot data information, the ASP would invoke a utility program to read the product lot data base into its central data base automatically. Based on the shipping schedule of the product lot, this lot data in the central data base is scheduled to go LIVE or ACTIVE on the same product shipping date. Until then these smartcards 202 and QR barcodes 103 are considered inactive and any query on these to the ASP server 250 will result an invalid barcode or smartcard identification message,

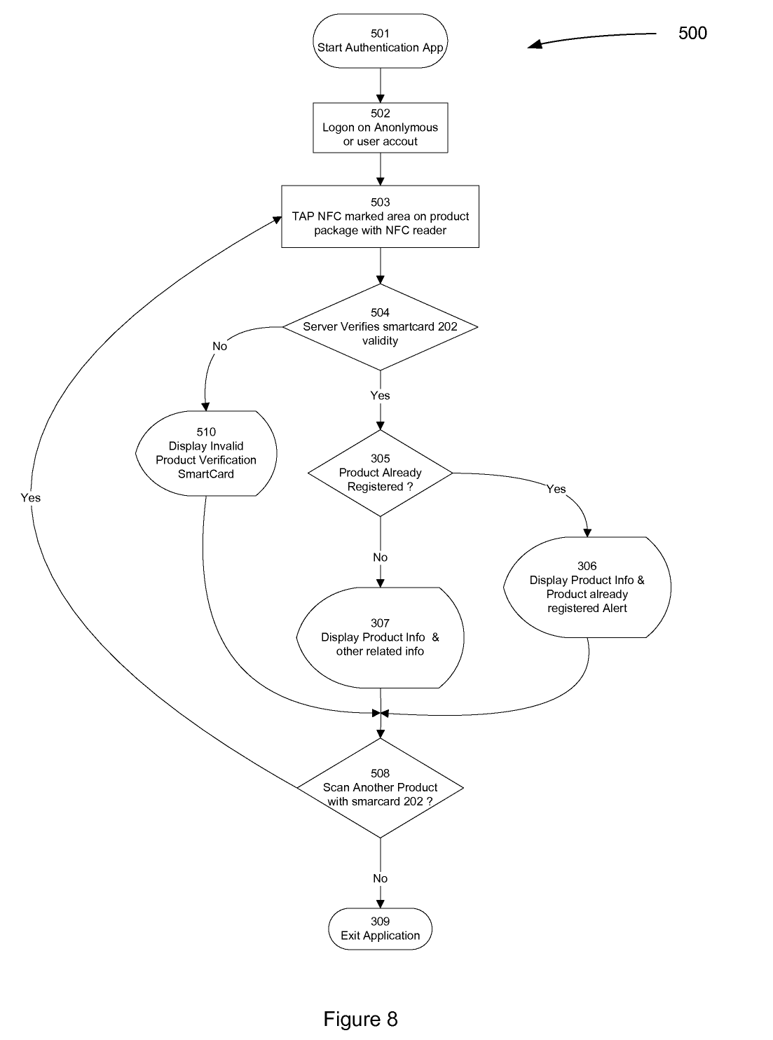

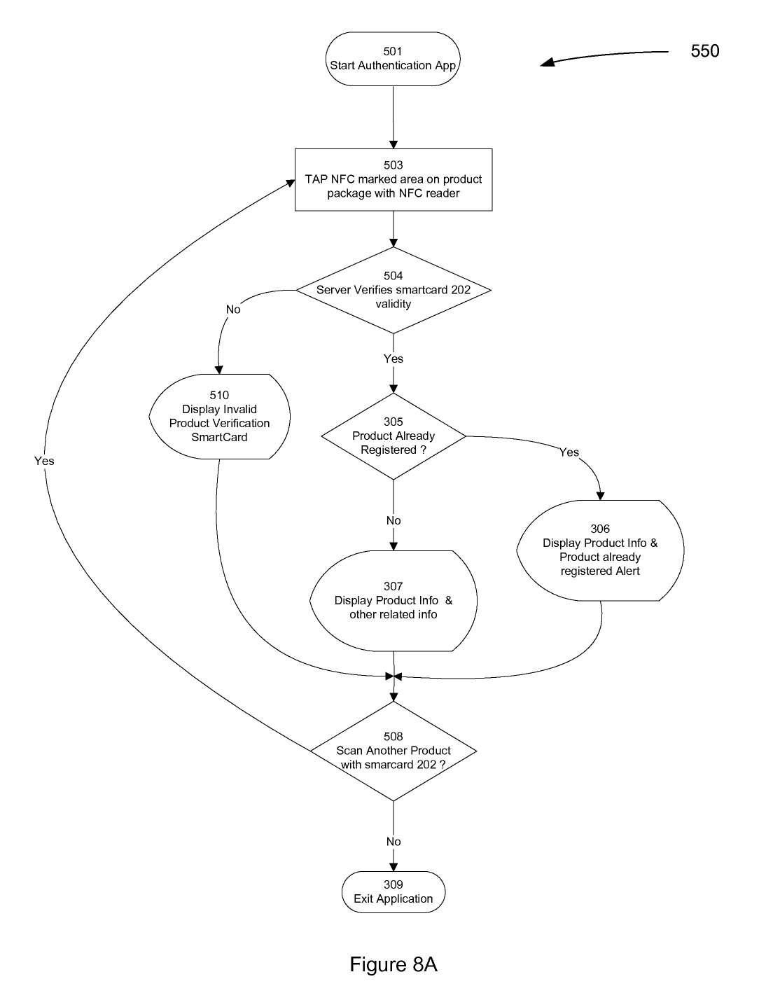

FIG. 8 illustrates another product authentication message flow. The consumer invokes authentication application (step 501) with an Internet enabled Smartphone 260, then logs on as either an anonymous user or her registered account (step 502) to the ASP server 250. Consumer is then instructed to use the Smartphone 260 to tap on the “NFC” mark 203 on the product 201. Typical reading distant between the NFC reader and proximity smartcard is less then 10 cm. If there are more than one smartcards sensed by the Smartphone 260, the NFC module in the Smartphone 260 would use anti-collision technology to read the smartcards sequentially. Consumer may opt to remove the product 201 from the shelf to perform the smartcard reading (step 503) in an open area. The ASP server 250 would authenticate the smartcard 202 based on the smartcard's unique ID and its stored secret. It also checks if the smartcard is ACTIVE and the corresponding product 201 had not been registered (step 305). If indeed, the smartcard 202 is valid and ACTIVE and product 201 had not been registered, the ASP server 250 would look up its data base to get the product 201 information and present them to the Smartphone 202. The product 101 information may include but not limited to product brand, make, model number, manufacturing date code, lot number, and serial number. In some applications, the ASP server 250 may opt to present additional information, such as how many times this smartcard 202 had been read, or product promotion alert, or in some rare case, a warning that the product is being recalled. After reviewing these product and additional information, consumer will be asked if she wants to authenticate another product (step 508). Consumer can move on to tap another product (step 503) or quit the application (step 309). Upon satisfied with the product message from 307, consumer then decides if she wants to purchase the product 201.

However, in some rare cases, the smartcard 202 could be damaged and that the Smartphone reader 260 cannot read it properly. After a predefined period, say 10 seconds, the ASP server 250 would present to the Smartphone 260 that the smartcard 202 is not valid or perhaps there were logistic shipping date error that the smartcard 202 status was INACTIVE. In some uncommon scenarios, the ASP server 250 recognizes that the product 201 had been registered based on its central data base information. The ASP server 250 may issue an alert message to Smartphone 260 that the product had been registered and alerts the consumer that product 201 might be a counterfeit. The consumer is further advised to take the product 201 to the customer service of the store. The ASP server 250 may collect the necessary information, to the extent that local laws allow, like the location-based data—IP address, user account, GPS (global positioning system) coordinates, time and date. The ASP central server would then generate a standard report on these “invalid” smartcard 202 and product 201 already registered incidents (PARI) automatically. The report may automatically route to the ASP customer service department for further review and actions if needed. In some cases, the product 201 manufacturer may be included in the report distribution. If indeed there were counterfeit products deemed being circulated, either the product manufacturer or the ASP customer service department may opt to report to the local law enforcement agency.

FIG. 8A shows a simplified version of authentication message flow. Consumer simply invokes the authentication application, scan the smartcard 202, review the authentication message, then scan another product or exit the application. The user login step is skipped

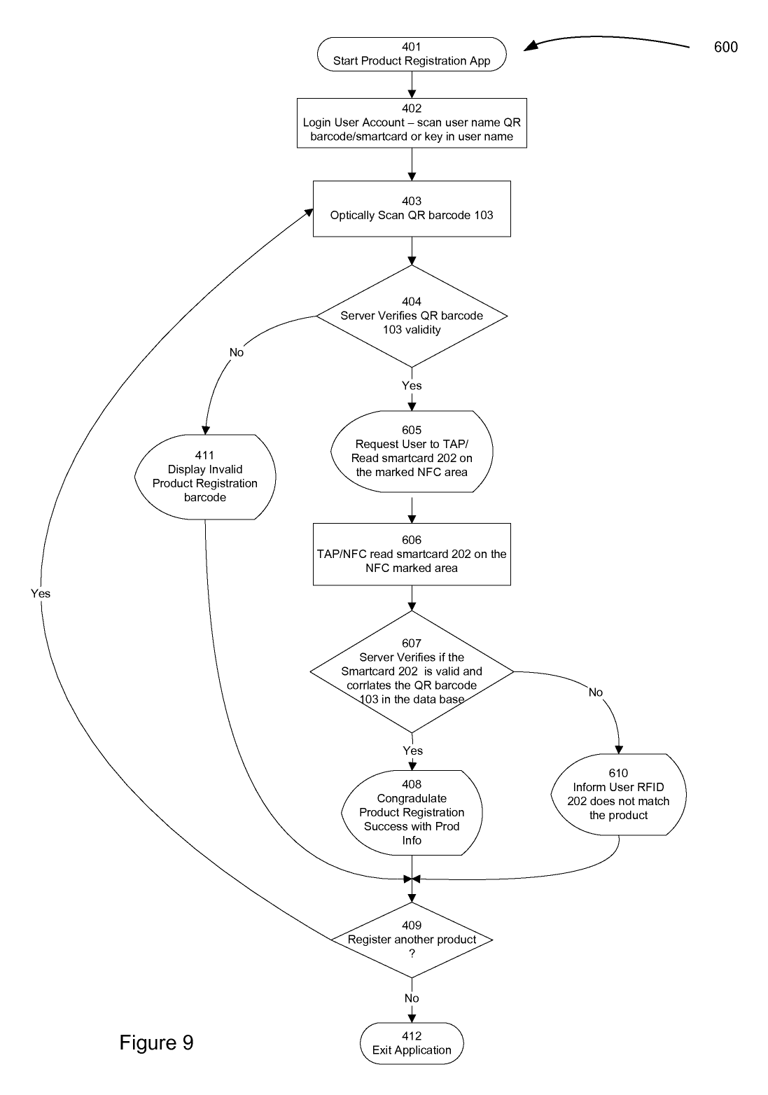

FIG. 9 shows a flow diagram for the consumer to register the product 201 after purchasing it. The consumer should have registered an account with the ASP. After invoking the product registration application 401, the consumer logs in her account either by keying in her user name or scanning her user name barcode or smartcard. Password is not needed in some cases since it is for product registration only. Consumer will be directed to find the QR barcode 103 which was concealed in an envelope 105. The consumer will then scan the QR barcode 103 with an Internet enabled Smartphone 260 or Internet enabled reader 250. After receiving the QR barcode 103 information, the ASP server 250 then verifies it (step 404). If the QR barcode 103 is both valid and ACTIVE based on the data base, the ASP server 250 would request the consumer to tap the “NFC” mark 203. The consumer then taps the NFC mark 203 (step 606) to read the smartcard 202 with the Smartphone 260. The ASP server 250 would verify if the smartcard 202 is valid and belongs to the same product 201 from its central database (step 607). If both smartcard 202 and QR barcode 103 match the data base information of the product 201, the ASP server 250 will present a congratulation message to the consumer that the product 201 was successfully registered to her account with the ASP. The ASP may opt to reward the consumer with some product loyalty program points, or it may alert the consumer with promotional products related the product 201. It then asks if the consumer wants to register another product. If the consumer has another product to register, then the process starts over from step 403, else the consumer can exit the registration application (step 412).

After product 101 or 201 is registered, the ASP may opt to change the QR barcode 102, QR barcode 103 or smartcard 202 to be INACTIVE. As such, any further queries based on these identifications will result an invalid or INACTIVE message. For some low value products, some consumer may not want to register them. As such these products related identification QR barcodes or smartcards may be ACTIVE indefinitely which is not desirable. The ASP may work out an agreement with product manufacturers that after a period of time, say five years, ASP have an option to remove such unregistered ids from its data base or treat them as out of date. In some other cases, the product manufacturers may request the ASP to keep the registered product QR barcodes 102, 103 and smartcards 202 ACTIVE for a period of time, for example, one year or longer which is to match their one year product warranty period. In some perishable or time sensitive produce or goods, the ASP may include an algorithm to automatically highlight the authentication message that the products have expired and alert the consumers not to use or consume them when the products reach the expiration dates.

FIG. 1A illustrates how a return product 101 gets repackaged. Some purchased products may be returned to the store for various reason like unsuitable to an application, change of personal color preference, or price was found higher than other local store. The store XYZ may work with the ASP to process the return products according a stringent flow. The store XYZ technician would thoroughly inspect the return product 101 and make sure all parts, components, instructions and original packages are in place. The technician would take out the original envelope 105 and pick up his store ordered envelope 905 which conceals a QR barcode 903. He then invokes a re-assembly application on a computer. He scans the store specific envelope 905 tracking barcode 904 and the product QR barcode 102 to log the code pair information to a re-assembly data base. He then inserts the envelop 905 inside the product 101 and wraps up the product 101, The re-assembled product 101 is then set aside in a re-assembled good holding area. Similar to the manufacturer, the store would encrypt the “re-assembled data base” and send it to the ASP electronically using public key, private key and private signing methodology. When the ASP receives the “re-assembled data base”, it would decrypt and verify the data base. It then invokes a utility program to read the re-assembled data base into the central data base. This would add new information to the original product 101 data entry such that the new barcode 903 would replace the original QR barcode 103 for product registration. Message to the user may include “product has been returned and repackaged by store XYZ on Jan. 20, 2011”, in addition to the original product information like date code, model number, serial number, etc. Afterwards, the ASP would electronically notify store XYZ that the central data base had successfully update with the product 101 re-assembled data. Upon receiving this message from the ASP, store XYZ would release the re-assembled product 101 and put it back on the store display shelf. This arrangement makes every party accountable for its actions. If anything goes wrong, it could be traced to the related party. The store XYZ needs to order a set of envelopes 905 from ASP prior to perform such re-assembly operation. The ASP central data base keeps such envelop 905 and their corresponding QR barcodes 903 information.

For product 102 which has smartcard 202 as identification, the return and reassembly process is similar except the QR barcode 903 scan data is replaced with the smartcard 9030 data.

For some products which have a used or resell private market, for example a baseball card signed by a famous professional athlete. The consumer may have all the intention to keep the smartcard 202 active indefinitely. As such, the ASP may serve this private market, possibly with a fee to extend the ACTIVE period of the smartcard with updated information, like the history of an antique from day one. Consumer can pull out such history with the smartcard 202 from the ASP central data base with Internet enabled Smartphone 260 anytime. For this application, the smartcard 202 becomes the product certificate or history access key while the ASP serves as both history data bank and gate keeper of the product information.

The smartcard 202 in conjunction with barcode 103 are well suited for high monetary value product authentication message applications. For some luxury products, the product manufacturers may opt to have the smartcard customized to a memorable item with expensive and high end decor. Owners of such products may proudly display their upscale look and feel smartcards 202 either at home or as attachment to the luxury product, for example, as a tag chained to a luxury hand bag strap. Similar to antiques and memorabilia, the luxury products would necessitate a longer smartcard 202 ACTIVE period, say 10 years after registration. The ASP may charge these product manufacturers a premium for such services. Incidentally, the long service period for these products creates a registry such that if the product is lost, the rightful owner could be traced if the product is later found. In addition, stolen or grey market goods can also be verified with this registry, provided that the smartcards 202 are still attached to these products. Consumers would feel that the smartcard 202 is a necessary item, like product birth certificates for their goods. Without them, it would be hard to place values and the history of their products.

As the ASP services multi product manufacturers, it may set up a business agreement to report their registered product user information as permitted by the local privacy law and with consents from the product owners to product manufacturers. The ASP may double as the manufacture's customer service for some small and medium size manufacturers. The ASP could deliver product information to consumers via emails or SMS texts while suggestions, comments, or inquiries from consumers could be routed from the ASP to the manufacturers. The ASP could also assist the manufacturer in collecting marketing information based on the demographic of the product authentication queries and the registration information. To some extent, the ASP could perform business intelligent analysis and report back to the manufacturer per their business arrangement.

In addition to keeping detail logs of products registered for account users, the ASP can help product manufacturer process rebate. Say a product manufacturer want to promote its new product, model T, to a city B only. The manufacturer would provide these city B promotional product lots data to ASP. Consumers would be encouraged to register these products after purchasing them to receive an incentive rebate. A program would then be set by the ASP to automatically trigger the rebate process after successful product registration from this specific set of smartcards 202 and QR barcodes 103. The ASP could set up an arrangement with an “added-value” service company like the Octopus Corporation in Hong Kong. As soon as a consumer successfully registers the product model T, the ASP would credit a fix value to the consumer's Octopus card electronically and bill the manufacturer. The consumer needs to register her Octopus card information with the ASP. Unlike a credit card, the consumer may feel comfortable doing so since the Octopus card has limited value. Other similar arrangement could be made to add value to say a consumer's cell phone account.

The consumer may have interest to accumulate customer loyalty points (LP) either provided by the product manufacturers or the ASP. The consumer may log in her account with the ASP to redeem her points to get discount on products or service. The consumer account with the ASP serves as a bridge between the consumer and product manufactures. It is where the manufacturers and the consumer can communicate on past, present or future product services, ideas, promotion or settlements.

The ASP needs to exercise diligence to audit and support the product manufacturers and retail stores. The ASP want to ensure the product assembly flow is secure such that product assembly personnel could not easily access the detail information of the product identification and the related data base information. It is also important those products being manufactured are legal and without bogus claims. Else, the ASP would be deemed as an accomplice in promoting illegal or bogus products. Meanwhile the ASP must secure its data base to guard against attack or sabotage.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
providing a product with a first machine readable label on the outside package and a second machine readable label accessible only once the package is opened and
enabling a computer to determine if a product is authentic using said first and second machine readable labels.

2. The method of claim 1 including concealing a second machine readable label in an envelope.

3. The method of claim 1 including shrink wrapping the packaged product.

4. The method of claim 1 including making sure that no two labels have the same code.

5. The method of claim 1 including enabling the code in the first machine readable label to be used to retrieve information about the product.

6. The method of claim 5 including enabling the code on the second machine readable label to provide information for authenticating the product.

7. The method of claim 1 including providing a link to information about product updates using one of said machine readable labels.

8. The method of claim 1 including using a QR code for each of said labels.

9. The method of claim 1 including using a bar code on each of said labels.

10. The method of claim 1 including using the second machine readable label to enable the user to register the product.

11. An apparatus comprising:
a product;
a package around said product, said package including an externally readable first machine readable label; and
a second machine readable label inside said package and not externally readable from outside said package.

12. The apparatus of claim 11 including an envelope surrounding said second machine readable label.

13. The apparatus of claim 11 wherein said package is shrink wrapped.

14. The apparatus of claim 11 wherein said labels do not have the same code.

15. The apparatus of claim 11 wherein the code of the first machine readable label is adapted to retrieve information about the product.

16. The apparatus of claim 15 wherein the code of the second machine readable label to provide information for authenticating the product.

17. The apparatus of claim 11 including a QR code on each of said labels.

18. The apparatus of claim 11 including a bar code on each of said labels.

19. The apparatus of claim 11 wherein second machine readable label to enable the user to register the product.
